(19) United States
(12) Patent Application Publication
(10) Pub. No.: US 2016/0330587 A1
(43) Pub. Date: Nov. 10, 2016

(54) INFORMATION OBTAINING METHOD, SERVER, TERMINAL, AND SYSTEM

(71) Applicant: Tencent Technology (Shenzhen) Company Limited, Shenzhen (CN)

(72) Inventors: Tao ZHANG, Shenzhen (CN); Lichun LI, Shenzhen (CN); Kai HE, Shenzhen (CN); Junda LI, Shenzhen (CN); Weixin LV, Shenzhen (CN); Feng LU, Shenzhen (CN); Sen WANG, Shenzhen (CN)

(21) Appl. No.: 15/216,268

(22) Filed: Jul. 21, 2016

Related U.S. Application Data
(63) Continuation of application No. PCT/CN2015/071283, filed on Jan. 22, 2015.

(30) Foreign Application Priority Data
Jan. 23, 2014 (CN) 201410030672.7

(51) Int. Cl. H04W 4/02

(52) U.S. Cl. CPC H04W 4/023

(57) ABSTRACT

An information obtaining method and system is provided, the system may include: a first terminal, a second terminal, and a server, where the first terminal reports position description information of a geographical building associated with a same identifier to a server; and the server determines position information of the geographical building according to the position description information of the geographical building, and obtains, according to the position information of the second terminal sent by the second terminal and the same identifier, the position information of the geographical building that is associated with the same identifier and of which a position relationship with the second terminal meets a preset condition. In this way, the position information of the second terminal and the position description information of the geographical building sent by the first terminal are both located by the server, thereby improving the accuracy of locating the geographical building.

### CROSS-REFERENCE TO RELATED APPLICATIONS

This application is a continuation of International Application No. PCT/CN2015/071283, filed on Jan. 22, 2015, which claims priority to Chinese Patent Application No. 201410030672.7, filed on Jan. 23, 2014, both of which are hereby incorporated by reference in their entireties.

### FIELD OF THE TECHNOLOGY

The present disclosure relates to the field of Internet technologies, and in particular, to an information obtaining method, server, terminal, and system.

### BACKGROUND

Nowadays, increasing more tenants not only have physical stores, but also sell by using a network. After viewing commodity information on a network, if a buyer needs to view a physical commodity, the buyer may also go to a physical store to take a look, which not only prevents the user from placing an order without seeing the commodity, but also prevents the buyer from strolling around various physical stores without a goal.

To make a buyer find a physical store conveniently, a tenant uploads geographical position description information of a physical store, for example, No. 2001, Shennan road, Shenzhen city. In a process of looking for a store, the buyer may locate, by using a global positioning system (GPS) of a terminal, information about a position of the buyer, and the terminal may further obtain position information of the physical store of the tenant from a server. In this way, the buyer may find the physical store according to the position information of the physical store and position information of the terminal that are displayed on the terminal.

Because a locating reference for the position information of the terminal may be different from a locating reference for the position information of the physical store, a deviation between a relative position of the position information of the terminal and a relative position of the position information of the physical store that are located according to different references is large; as a result, the buyer cannot find the physical store very conveniently.

### SUMMARY

Embodiments of the present disclosure provide an information obtaining method, which can determine, by using a same server, position information of a geographical building and position information of a user terminal that are required by a user, thereby improving the accuracy of locating the geographical building. The embodiments of the present disclosure further provide a corresponding server, terminal, and system.

Embodiments of the present disclosure provides an information obtaining method, including: reporting, by a first terminal, position description information of a geographical building associated with a same identifier to a server; determining, by the server, position information of the geographical building according to the position description information of the geographical building, and storing the same identifier and the position information of the geographical building in an associated manner; sending, by a second terminal, a position information obtaining request to the server, where the position information obtaining request carries the same identifier and position information of the second terminal, and a locating reference of the second terminal is the same as a locating reference of the server, obtaining, by the server according to the position information of the second terminal and the same identifier, the position information of the geographical building that is associated with the same identifier and of which a position relationship with the second terminal meets a preset condition; sending, by the server to the second terminal, the position information of the geographical building that is associated with the same identifier and of which the position relationship with the second terminal meets the preset condition; and displaying, by the second terminal, the position information of the geographical building that is associated with the same identifier and of which the position relationship with the second terminal meets the preset condition.

Embodiments of the present disclosure provides an information obtaining method, including: receiving position description information, which is reported by a first terminal, of a geographical building associated with a same identifier; determining position information of the geographical building according to the position description information of the geographical building, and storing the same identifier and the position information of the geographical building in an associated manner; receiving a position information obtaining request sent by a second terminal, where the position information obtaining request carries the same identifier and position information of the second terminal, and a locating reference of the second terminal is the same as a locating reference of the server, obtaining, according to the position information of the second terminal and the same identifier, the position information of the geographical building that is associated with the same identifier and of which a position relationship with the second terminal meets a preset condition; and sending, to the second terminal, the position information of the geographical building that is associated with the same identifier and of which the position relationship with the second terminal meets the preset condition.

Embodiments of the present disclosure provides a server, including: a receiving unit, configured to receive position description information, which is reported by a first terminal, of a geographical building associated with a same identifier; a determining unit, configured to determine position information of the geographical building according to the position description information of the geographical building received by the receiving unit; a storage unit, configured to store, in an associated manner, the same identifier and the position information of the geographical building determined by the determining unit, where the receiving unit is further configured to receive a position information obtaining request sent by a second terminal, where the position information obtaining request carries the same identifier and position information of the second terminal, and a locating reference of the second terminal is the same as a locating reference of the server; an obtaining unit, configured to obtain, according to the position information of the second terminal received by the receiving unit and the same identifier, the position information of the geographical building that is associated with the same identifier and of which a position relationship with the second terminal meets a preset condition; and a sending unit, configured to send, to the second terminal, the position information, which is obtained by the obtaining unit, of the geographical building that is associated with the same identifier and of which the position relationship with the second terminal meets the preset condition.

Embodiments of the present disclosure provides an information obtaining system, including: a first terminal, a second terminal, and a server, where the first terminal, the second terminal, and the server are in communication connection; the first terminal reports position description information of a geographical building associated with a same identifier to a server; the server determines position information of the geographical building according to the position description information of the geographical building, and stores the same identifier and the position information of the geographical building in an associated manner, the second terminal sends a position information obtaining request to the server, where the position information obtaining request carries the same identifier and position information of the second terminal, and a locating reference of the second terminal is the same as a locating reference of the server; the server obtains, according to the position information of the second terminal and the same identifier, the position information of the geographical building that is associated with the same identifier and of which a position relationship with the second terminal meets a preset condition; the server sends, to the second terminal, the position information of the geographical building that is associated with the same identifier and of which the position relationship with the second terminal meets the preset condition; and the second terminal displays the position information of the geographical building that is associated with the same identifier and of which the position relationship with the second terminal meets the preset condition.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show some embodiments of the present disclosure, and a person of ordinary skill in the art may still derive other drawings from these accompanying drawings without creative efforts.

FIG. 1 is a schematic diagram of an embodiment of a position information obtaining method according to an embodiment of the present disclosure;

FIG. 2 is a schematic diagram of an embodiment of a server according to an embodiment of the present disclosure;

FIG. 3 is a schematic diagram of another embodiment of a terminal according to an embodiment of the present disclosure;

FIG. 4 is a schematic diagram of another embodiment of a position information obtaining method according to an embodiment of the present disclosure;

FIG. 5 is a schematic diagram of another embodiment of a position information obtaining method according to an embodiment of the present disclosure;

FIG. 6 is a schematic diagram of another embodiment of a server according to an embodiment of the present disclosure;

FIG. 7 is a schematic diagram of another embodiment of a server according to an embodiment of the present disclosure;

FIG. 8 is a schematic diagram of another embodiment of a terminal according to an embodiment of the present disclosure;

FIG. 9 is a schematic diagram of another embodiment of a terminal according to an embodiment of the present disclosure; and

FIG. 10 is a schematic diagram of an embodiment of an information obtaining system according to an embodiment of the present disclosure.

### DESCRIPTION OF EMBODIMENTS

Embodiments of the present disclosure provide an information obtaining method, which can determine, by using a same server, position information of a geographical building and position information of a user terminal that are required by a user, thereby improving the accuracy of locating the geographical building. The embodiments of the present disclosure further provide a corresponding server, terminal, and system. The following provides detailed descriptions separately.

The following clearly and completely describes the technical solutions in the embodiments of the present disclosure with reference to the accompanying drawings in the embodiments of the present disclosure. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

Referring to FIG. 1, an embodiment of an information obtaining method provided by an embodiment of the present disclosure includes: a first terminal, a second terminal, and a server, where the first terminal and the second terminal communicate with the server by using a mobile network and the Internet.

The first terminal reports position description information of a geographical building associated with a same identifier to the server.

The same identifier may be a registered identifier of a tenant, for example, a registered identifier of the Prince Jewellery & Watch Company. There may be multiple pieces of the position description information of the geographical building associated with the same identifier, for example, the Prince Jewellery & Watch Company has multiple exclusive stores, and then position information of the multiple exclusive stores is associated with the same identifier.

The position description information of the geographical building may be information such as a street or a gate number.

The server determines position information of the geographical building according to the position description information of the geographical building, and stores the same identifier and the position information of the geographical building in an associated manner.

The position information of the geographical building may be latitude and longitude information of a geographical position.

A GPS may be stored at a server end, and therefore the server may determine the position information of the geographical building according to the position description information of the geographical building. Using that the position information is latitude and longitude information as an example, for example, latitude and longitude information of No. 156, Tsim Sha Tsui in Hongkong may be 22.53 degrees north latitude and 113.55 degrees east longitude. Certainly, there are multiple exclusive stores of the Prince Jewellery & Watch Company, and then there are multiple pieces of latitude and longitude information of the geographical building associated with the registered identifier of the Prince Jewellery & Watch Company.

The second terminal sends a position information obtaining request to the server, where the position information obtaining request carries the same identifier and position information of the second terminal, and a locating reference of the second terminal is the same as a locating reference of the server.

For example, a user sends the information obtaining request to the server by using the second terminal, where the position information obtaining request carries the registered identifier of the Prince Jewellery & Watch Company and the position information of the second terminal.

For example, a tenant on WeChat reports the position description information of the geographical building to the server by using a WeChat client on the first terminal, and the user reports the position information of the second terminal to the server by using a WeChat client on the second terminal; in this way, the locating reference of the second terminal and the locating reference of the server may remain the same.

The server obtains, according to the position information of the second terminal and the same identifier, the position information of the geographical building that is associated with the same identifier and of which a position relationship with the second terminal meets a preset condition.

For example, there are 50 pieces of position information of the geographical building associated with the registered identifier of the Prince Jewellery & Watch Company, and there are information of 5 positions of which position relationships with the second terminal meet the preset condition, which are, for example, A, B, C, D, and E separately, and the server finally determines the information of the 5 positions, which are A, B, C, D, and E.

The server sends, to the second terminal, the position information of the geographical building that is associated with the same identifier and of which the position relationship with the second terminal meets the preset condition.

The server sends the information of the 5 positions, which are A, B, C, D, and E, to the second terminal.

The second terminal displays the position information of the geographical building that is associated with the same identifier and of which the position relationship with the second terminal meets the preset condition.

The second terminal displays the information of the 5 positions, which are A, B, C, D, and E. The user then can determine a destination according to the information of the 5 positions, which are A, B, C, D, and F.

Compared with that a locating reference for position information of a terminal is different from a locating reference for position information of a physical store in the prior art, which causes a large deviation between a relative position of the position information of the terminal and a relative position of the position information of the physical store, the information obtaining method provided by this embodiment of the present disclosure can determine, by using a same server, position information of a geographical building and position information of a user terminal that are required by a user, thereby improving the accuracy of locating the geographical building.

Optionally, in another embodiment of the information obtaining method provided by this embodiment of the present disclosure,

the server obtains, according to the same identifier, the position information of the geographical building associated with the same identifier;

the server determines, according to the position information of the second terminal, the position information of the geographical building of which a distance to the second terminal is within a preset range;

the server sends the position information of the geographical building of which the distance to the second terminal is within the preset range to the second terminal; and

the second terminal displays the position information of the geographical building of which the distance to the second terminal is within the preset range.

For example, after the server determines that there are 50 pieces of position information of the geographical building associated with the registered identifier of the Prince Jewellery & Watch Company, if the preset range of the distance to the second terminal is 500 meters, the server determines, from the 50 pieces of position information, information of a position of which a distance to the second terminal is within a range of 500 meters. For example, it is determined that there are information of 5 positions, which are A, B, C, D, and E, of which distances to the second terminal are within the range of 500 meters, and then the server sends the information of the 5 positions, which are A, B, C, D, and E, to the second terminal. The second terminal displays the information of the 5 positions, which are A, B, C, D, and F. The user then can determine a destination according to the information of the 5 positions, which are A, B, C, D, and E.

Optionally, in another embodiment of the information obtaining method provided by this embodiment of the present disclosure, when the position information of the second terminal is range information of a service area in which the second terminal is located, the server obtains, according to the same identifier, the position information of the geographical building associated with the same identifier; and the server determines, according to the range information of the service area in which the second terminal is located, the position information of the geographical building in the service area in which the second terminal is located.

The server sends, to the second terminal, the position information of the geographical building in the service area in which the second terminal is located; and

the second terminal displays the position information of the geographical building in the service area in which the second terminal is located.

For example, after the server determines that there are 50 pieces of position information of the geographical building associated with the registered identifier of the Prince Jewellery & Watch Company, if a position of the service area in which the second terminal is located is displayed in Tsim Sha Tsui, the server determines, from the 50 pieces of the position information, information of positions within a range of Tsim Sha Tsui. For example, it is determined that there are information of 5 positions, which are A, B, C, D, and E, within the range of Tsim Sha Tsui, and then the server sends the information of the 5 positions, which are A, B, C, D, and E, to the second terminal. The second terminal displays the information of the 5 positions, which are A, B, C, D, and E. The user then can determine a destination according to the information of the 5 positions, which are A, B, C, D, and E.

Optionally, in another embodiment of the information obtaining method provided by this embodiment of the present disclosure, the method may further include:

receiving, by the second terminal, a selection instruction input by a user, where the selection instruction is used to instruct to select the position information of the geographical building specified by the user; and

selecting, according to the selection instruction, the position information of the geographical building specified by the user.

In this embodiment of the present disclosure, after the second terminal displays the information of the 5 positions, which are A, B, C, D, and E, the user inputs the selection instruction; and if the selection instruction instructs to select A, the second terminal selects A.

Optionally, in another embodiment of the information obtaining method provided by this embodiment of the present disclosure, the method may further include:

receiving, by the server, the position information, which is selected by the user and reported by the second terminal, of the geographical building;

determining, according to the position information, which is selected by the user, of the geographical building, content information associated with the position information, which is selected by the user, of the geographical building; and

sending the content information associated with the position information, which is selected by the user, of the geographical building to the second terminal.

In this embodiment of the present disclosure, after the user selects A, the second terminal reports the information of the position A selected by the user to the server, and the server determines, according to the information of the position A, content information associated with A. The content information may be promotion activity information, and the like. In this way, after receiving the content information associated with the information of the position A, the second terminal can learn a promotion activity situation of A.

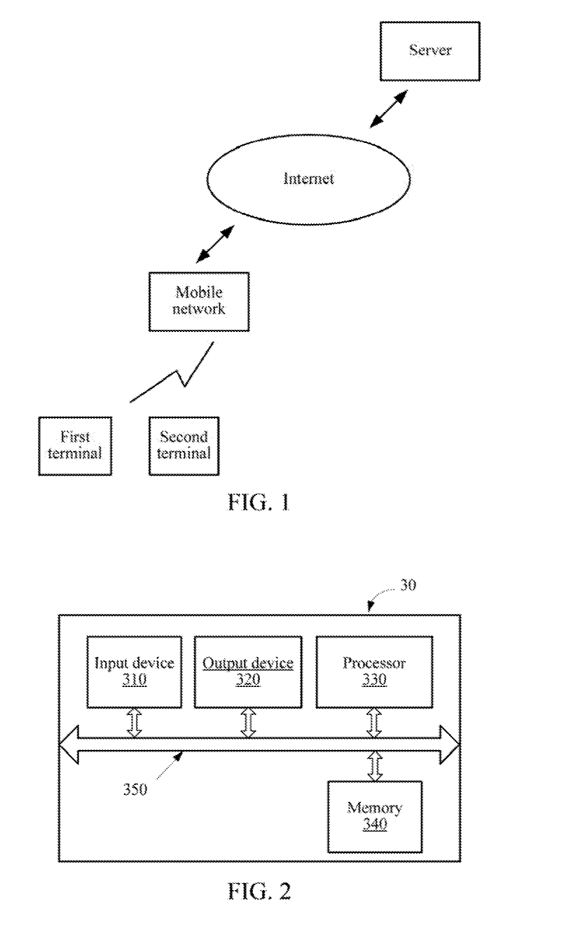

Reference may be made to FIG. 2 to understand the structure of a server 30, where the server 30 may include an input device 310, an output device 320, a processor 330, and a memory 340.

The memory 340 may include a read-only memory (ROM) and a random access memory (RAM), and provide an instruction and data for the processor 330. A part of the memory 340 may further include a nonvolatile random access memory (NVRAM).

The memory 340 stores the following elements, executable modules, data structures, subsets thereof, or extended sets thereof:

an operation instruction: including various operation instructions, used to implement various operations; and

an operating system: including various system programs, used to implement various basic services and process hardware-based tasks.

In this embodiment of the present disclosure, the processor 330 performs the following operations by invoking the operation instruction stored in the memory 340 (the operation instruction may be stored in an operating system):

receiving, by using the input device 310, position description information, which is reported by a first terminal, of a geographical building associated with a same identifier;

determining position information of the geographical building according to the position description information of the geographical building, and storing the same identifier and the position information of the geographical building in an associated manner;

receiving, by using the input device 310, a position information obtaining request sent by a second terminal, where the position information obtaining request carries the same identifier and position information of the second terminal, and a locating reference of the second terminal is the same as a locating reference of the server;

obtaining, according to the position information of the second terminal and the same identifier, the position information of the geographical building that is associated with the same identifier and of which a position relationship with the second terminal meets a preset condition; and

sending, to the second terminal by using the output device 320, the position information of the geographical building that is associated with the same identifier and of which the position relationship with the second terminal meets the preset condition.

Compared with that a locating reference for position information of a terminal is different from a locating reference for position information of a physical store in the prior art, which causes a large deviation between a relative position of the position information of the terminal and a relative position of the position information of the physical store, the server provided by this embodiment of the present disclosure determines position information of a geographical building and position information of a user terminal that are required by a user, thereby improving the accuracy of locating the geographical building.

The processor 330 controls an operation of the server 30, and the processor 330 may also be referred to as a central processing unit (CPU). The memory 340 may include a ROM and a RAM, and provide an instruction and data for the processor 330. A part of the memory 340 may further include an NVRAM. In a specific application, components of the server 30 are coupled together through a bus system 350, where, in addition to a data bus, the bus system 350 may further include a power bus, a control bus, and a state signal bus. However, for clear description, various buses are marked as the bus system 350 in the figure.

The method disclosed in the foregoing embodiment of the present disclosure may be applied to the processor 330, or may be implemented by the processor 330. The processor 330 may be an integrated circuit chip and has a signal processing capability. In an implementation process, steps of the foregoing method may be completed by using an integrated logic circuit of hardware or instructions in a software form in the processor 330. The processor 330 may be a general processor, a digital signal processor (DSP), an application-specific integrated circuit (ASIC), a field programmable gate array (FPGA), another programmable logical device, a discrete gate, a transistor logic device, or a discrete hardware component, which can implement or execute methods, steps, and logic block diagrams disclosed in the embodiments of the present disclosure. The general processor may be a microprocessor or the processor may be any common processor, or the like. The steps of the method disclosed in the embodiments of the present disclosure may be directly executed and completed by a hardware decoding processor or be executed and completed by a combination of hardware and software modules in the decoding processor. The software module may be located in a mature storage medium in the art, such as a RAM, a flash memory, a ROM, a programmable ROM, an electronically erasable programmable memory, and a register. The storage medium is located in the memory 340, and the processor 330 reads information in the memory 340, and completes the step of the method with reference to the hardware of the processor 330.

Optionally, the processor 330 may obtain, according to the same identifier, the position information of the geographical building associated with the same identifier, and determine, according to the position information of the second terminal, the position information of the geographical building of which a distance to the second terminal is within a preset range.

The output device 320 sends the position information of the geographical building of which the distance to the second terminal is within the preset range to the second terminal.

Optionally, when the position information of the second terminal is range information of a service area in which the second terminal is located, the processor 330 may obtain, according to the same identifier, the position information of the geographical building associated with the same identifier, and determine, according to the range information of the service area in which the second terminal is located, the position information of the geographical building in the service area in which the second terminal is located.

The output device 320 sends, to the second terminal, the position information of the geographical building in the service area in which the second terminal is located.

Optionally, the input device 310 is further configured to receive the position information, which is selected by a user and reported by the second terminal, of the geographical building:

the processor is further configured to determine, according to the position information, which is selected by the user, of the geographical building, content information associated with the position information, which is selected by the user of the geographical building; and

the output device 320 is further configured to send the content information associated with the position information, which is selected by the user, of the geographical building to the second terminal.

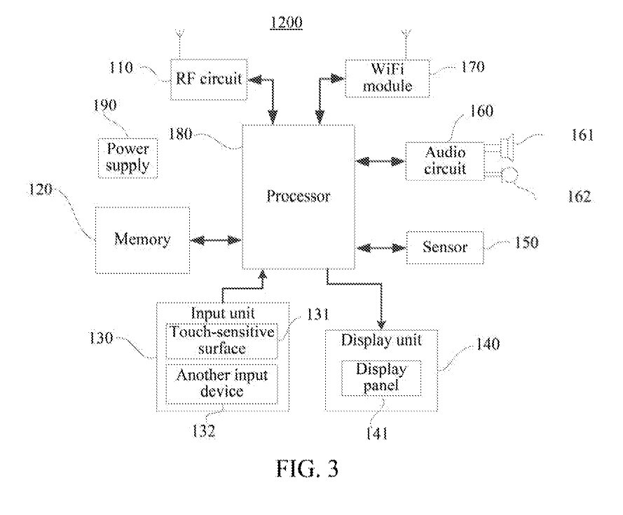

Reference may be made to FIG. 3 to understand the structures of the first terminal and the second terminal. A terminal 1200 shown in FIG. 3 may include components such as a radio frequency (RF) circuit 110, a memory 120 that includes one or more computer readable storage mediums, an input unit 130, a display unit 140, a sensor 150, an audio circuit 160, a wireless fidelity (WiFi) module 170, a processor 180 that includes one or more processing cores, and a power supply 190. A person skilled in the art can understand that, the structure of the terminal shown in FIG. 3 does not constitute a limitation to the terminal, and the terminal may include more components or fewer components than those shown in the figure, or some components may be combined, or a different component deployment may be used.

The RF circuit 110 may be configured to report position description information of a geographical building associated with a same identifier to the server, or sends a position information obtaining request to the server, where the position information obtaining request carries the same identifier and position information of the second terminal.

The RF circuit 110 may be further configured to receive position information, which is sent by the server, of a geographical building that is associated with the same identifier and of which a position relationship with the second terminal meets a preset condition, or report the position information, which is selected by the user, of the geographical building to the server.

The RF circuit 110 may be further configured to receive and send a signal during an information receiving and sending process or a conversation process, and particularly, receive downlink information from a base station, then delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by wireless communication. The wireless communication may use any communications standard or protocol, which includes, but is not limited to, Global System for Mobile communications (GSM), a General Packet Radio Service (GPRS), Code Division Multiple Access (CDMA), Wideband Code Division Multiple Access (WCDMA), Long Term Evolution (LTE), e-mail, Short Messaging Service (SMS), and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program required by at least one function (such as a sound playback function and an image display function), and the like. The data storage area may store data (such as audio data and an address book) created according to use of the terminal 1200, and the like. In addition, the memory 120 may include a high speed RAM, and may also include a non-volatile memory, such as at least one magnetic disk storage device, a flash memory, or another volatile solid storage device. Accordingly, the memory 120 may further include a memory controller, so that the processor 180 and the input unit 130 access the memory 120.

The input unit 130 may be configured to receive a selection instruction input by a user, where the selection instruction is used to instruct to select the position information of the geographical building specified by the user.

The input unit 130 may be further configured to receive input digit or character information, and generate keyboard, mouse, joystick, optical, or track ball signal input related to the user setting and function control. Specifically, the input unit 130 may include a touch-sensitive surface 131 and another input device 132. The touch-sensitive surface 131 may also be referred to as a touch screen or a touch panel, and may collect a touch operation of a user on or near the touch-sensitive surface (such as an operation of a user on or near the touch-sensitive surface 131 by using any suitable object or attachment, such as a finger or a touch pen), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be implemented by using various types, such as a resistive type, a capacitance type, an infrared type, and a surface sound wave type. In addition to the touch-sensitive surface 131, the input unit 130 may further include the another input device 132. Specifically, the another input device 132 may include, but is not limited to, one or more of a physical keyboard, a functional key (such as a volume control key or a switch key), a track ball, a mouse, and a joystick.

The display unit 140 may be configured to display the position information of the geographical building that is associated with the same identifier and of which the position relationship with the second terminal meets the preset condition.

The display unit 140 may be further configured to display information input by the user or information provided for the user, and various graphical user ports of the terminal 1200. The graphical user ports may be formed by a graph, a text, an icon, a video, and any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine a type of a touch event. Then, the processor 180 provides corresponding visual output on the display panel 141 according to the type of the touch event. Although, in FIG. 3, the touch-sensitive surface 131 and the display panel 141 are used as two separate parts to implement input and output functions, in some embodiments, the touch-sensitive surface 131 and the display panel 141 may be integrated to implement the input and output functions.

The terminal 1200 may further include at least one sensor 150, such as an optical sensor, a motion sensor, and other sensors. Specifically, the optical sensor may include an ambient light sensor and a proximity sensor. The ambient light sensor may adjust luminance of the display panel 141 according to brightness of the ambient light. The proximity sensor may switch off the display panel 141 and/or backlight when the terminal 1200 is moved to the ear. As one type of motion sensor, a gravity acceleration sensor may detect magnitude of accelerations at various directions (which generally are triaxial), may detect magnitude and a direction of the gravity when static, and may be configured to identify an application of a mobile phone gesture (such as switchover between horizontal and vertical screens, a related game, and gesture calibration of a magnetometer), a related function of vibration identification (such as a pedometer and a knock). Other sensors, such as a gyroscope, a barometer, a hygrometer, a thermometer, and an infrared sensor, which may be configured in the terminal 1200, are not further described herein.

The audio circuit 160, a loudspeaker 161, and a microphone 162 may provide audio interfaces between the user and the terminal 1200. The audio circuit 160 may transmit, to the loudspeaker 161, an electric signal converted from received audio data. The loudspeaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RF circuit 110, or outputs the audio data to the memory 120 for further processing. The audio circuit 160 may further include an earplug jack, so as to provide communication between a peripheral earphone and the terminal 1200.

WiFi belongs to a short distance wireless transmission technology. The terminal 1200 may help, by using the WiFi module 170, a user to receive and send an e-mail, browse a webpage, and access stream media, and the like, which provides wireless broadband Internet access for the user. Although FIG. 3 shows the WiFi module 170, it may be understood that, the WiFi module 170 does not belong to a necessary constitution of the terminal 1200, and can be ignored according to demands without changing the scope of the essence of the present disclosure.

The processor 180 is a control center of the terminal 1200, and connects to various parts of the terminal by using various interfaces and lines. By running or executing the software program and/or module stored in the memory 120, and invoking data stored in the memory 120, the processor 180 performs various functions and data processing of the terminal 1200, thereby performing overall monitoring on the mobile phone. Optionally, the processor 180 may include one or more processing cores. Preferably, the processor 180 may integrate an application processor and a modem. The application processor mainly processes an operating system, a user interface, an application program, and the like. The modem mainly processes wireless communication. It may be understood that, the foregoing modem may be not integrated into the processor 180.

The terminal 1200 further includes the power supply 190 (such as a battery) for supplying power to the components. Preferably, the power supply may logically connect to the processor 180 by using a power supply management system, thereby implementing functions, such as charging, discharging, and power consumption management, by using the power supply management system. The power supply 190 may further include any component, such as one or more direct current or alternate current power supplies, a re-charging system, a power supply fault detection circuit, a power supply converter or an inverter, and a power supply state indicator.

Although not shown in the figure, the terminal 1200 may further include a camera, a Bluetooth module, and the like, which are not described in detail herein again. Specifically, in this embodiment, the display unit of the terminal is a touch screen display, and the terminal further includes a memory and one or more programs. The one or more programs are stored in the memory and configured to be executed by one or more processors. The one or more programs include instructions used for performing the following operations:

sending a position information obtaining request to a server, where the position information obtaining request carries a same identifier and position information of a second terminal;

receiving position information, which is sent by the server, of a geographical building that is associated with the same identifier and of which a position relationship with the second terminal meets a preset condition; and

displaying the position information of the geographical building that is associated with the same identifier and of which the position relationship with the second terminal meets the preset condition.

In a second possible implementation manner that is provided based on a first possible implementation manner, the memory in the terminal further includes instructions used for performing the following operations:

receiving the position information, which is sent by the server, of the geographical building of which a distance to the second terminal is within a preset range; and

displaying the position information of the geographical building of which the distance to the second terminal is within the preset range.

In a third possible implementation manner that is provided based on the first possible implementation manner, the memory in the terminal further includes instructions used for performing the following operations:

receiving, when the position information of the second terminal is range information of a service area in which the second terminal is located, the position information, which is sent by the server, of the geographical building in the service area in which the second terminal is located; and

displaying the position information of the geographical building in the service area in which the second terminal is located.

In a fourth possible implementation manner that is provided based on any one of the first to third possible implementation manners, the memory in the terminal further includes instructions used for performing the following operations:

receiving a selection instruction input by a user, where the selection instruction is used to instruct to select the position information of the geographical building specified by the user;

selecting, according to the selection instruction, the position information of the geographical building specified by the user; and

reporting the position information, which is selected by the user, of the geographical building to the server.

According to another aspect, still another embodiment of the present disclosure further provides a computer readable storage medium, where the computer readable storage medium may be a computer readable storage medium included in the memory in the foregoing embodiment, and may also be a computer readable storage medium that exists separately and is not assembled into the terminal. One or more programs may be stored in the computer readable storage medium, and the one or more programs are used by one or more processors to execute an information obtaining method, where the method includes:

sending a position information obtaining request to a server, where the position information obtaining request carries a same identifier and position information of a second terminal;

receiving position information, which is sent by the server, of a geographical building that is associated with the same identifier and of which a position relationship with the second terminal meets a preset condition; and

displaying the position information of the geographical building that is associated with the same identifier and of which the position relationship with the second terminal meets the preset condition.

It is assumed that the foregoing is a first possible implementation manner, and then in a second possible implementation manner that is provided based on the first possible implementation manner, when the position information of the second terminal is position information of the second terminal, the receiving position information, which is sent by the server, of a geographical building that is associated with the same identifier and of which a position relationship with the second terminal meets a preset condition includes:

receiving the position information, which is sent by the server, of the geographical building of which a distance to the second terminal is within a preset range; and

the displaying the position information of the geographical building that is associated with the same identifier and of which a position relationship with the second terminal meets a preset condition includes:

displaying the position information of the geographical building of which the distance to the second terminal is within the preset range.

In a third possible implementation manner that is provided based on the first possible implementation manner, when the position information of the second terminal is range information of a service area in which the second terminal is located, the receiving position information, which is sent by the server, of a geographical building that is associated with the same identifier and of which a position relationship with the second terminal meets a preset condition includes:

receiving the position information, which is sent by the server, of the geographical building in the service area in which the second terminal is located; and

the displaying the position information of the geographical building that is associated with the same identifier and of which a position relationship with the second terminal meets a preset condition includes:

displaying the position information of the geographical building in the service area in which the second terminal is located.

In a fourth possible implementation manner that is provided based on the first to third possible implementation manners, the method further includes:

receiving a selection instruction input by a user, where the selection instruction is used to instruct to select the position information of the geographical building specified by the user;

selecting, according to the selection instruction, the position information of the geographical building specified by the user; and

reporting the position information, which is selected by the user, of the geographical building to the server.

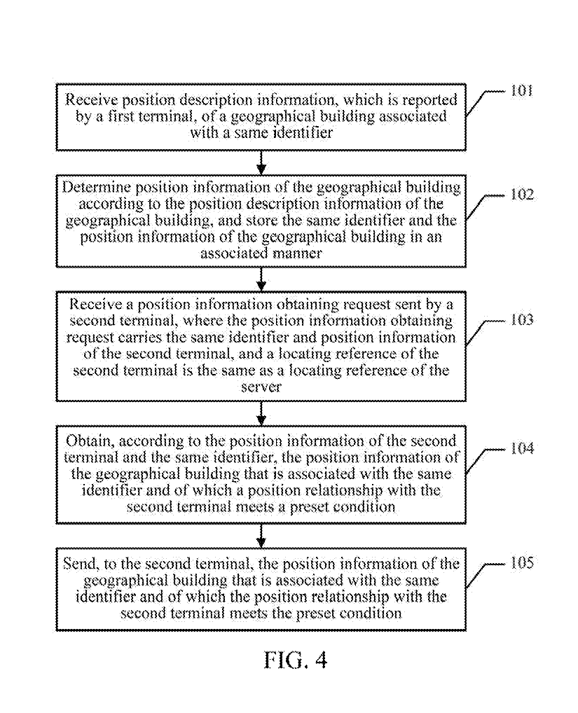

Referring to FIG. 4, an embodiment of an information obtaining method provided by an embodiment of the present disclosure includes:

101: Receive position description information, which is reported by a first terminal, of a geographical building associated with a same identifier.

102: Determine position information of the geographical building according to the position description information of the geographical building, and store the same identifier and the position information of the geographical building in an associated manner.

103: Receive a position information obtaining request sent by a second terminal, where the position information obtaining request carries the same identifier and position information of the second terminal, and a locating reference of the second terminal is the same as a locating reference of the server.

104: Obtain, according to the position information of the second terminal and the same identifier, the position information of the geographical building that is associated with the same identifier and of which a position relationship with the second terminal meets a preset condition.

105: Send, to the second terminal, the position information of the geographical building that is associated with the same identifier and of which the position relationship with the second terminal meets the preset condition.

Reference may be made to the embodiment corresponding to FIG. 1 to understand the information obtaining method described in this embodiment of the present disclosure, which are not described in detail herein again.

Compared with that a locating reference for position information of a terminal is different from a locating reference for position information of a physical store in the prior art, which causes a large deviation between a relative position of the position information of the terminal and a relative position of the position information of the physical store, the information obtaining method provided by this embodiment of the present disclosure can determine, by using a same server, position information of a geographical building and position information of a user terminal that are required by a user, thereby improving the accuracy of locating the geographical building.

Optionally, in another embodiment of the information obtaining method provided by this embodiment of the present disclosure, the obtaining, according to the position information of the second terminal and the same identifier, the position information of the geographical building that is associated with the same identifier and of which a position relationship with the second terminal meets a preset condition may include:

obtaining, according to the same identifier, the position information of the geographical building associated with the same identifier; and

determining, according to the position information of the second terminal, the position information of the geographical building of which a distance to the second terminal is within a preset range.

The sending, to the second terminal, the position information of the geographical building that is associated with the same identifier and of which a position relationship with the second terminal meets a preset condition includes:

sending the position information of the geographical building of which the distance to the second terminal is within the preset range to the second terminal.

Optionally, in another embodiment of the information obtaining method provided by this embodiment of the present disclosure, when the position information of the second terminal is range information of a service area in which the second terminal is located, the obtaining, according to the position information of the second terminal and the same identifier, the position information of the geographical building that is associated with the same identifier and of which a position relationship with the second terminal meets a preset condition may include:

obtaining, according to the same identifier, the position information of the geographical building associated with the same identifier; and

determining, according to the range information of the service area in which the second terminal is located, the position information of the geographical building in the service area in which the second terminal is located.

The sending, to the second terminal, the position information of the geographical building that is associated with the same identifier and of which a position relationship with the second terminal meets a preset condition may include:

sending, to the second terminal, the position information of the geographical building in the service area in which the second terminal is located.

Optionally, in another embodiment of the information obtaining method provided by this embodiment of the present disclosure, the method may further include:

receiving the position information, which is selected by the user and reported by the second terminal, of the geographical building;

determining, according to the position information, which is selected by the user, of the geographical building, content information associated with the position information, which is selected by the user, of the geographical building; and

sending the content information associated with the position information, which is selected by the user, of the geographical building to the second terminal.

Reference may be made to functions of the server in the embodiments corresponding to FIG. 1 to FIG. 3 to understand the information obtaining method described in the embodiment corresponding to FIG. 4 and optional embodiments of the present disclosure, which are not described in detail herein again.

Compared with that a locating reference for position information of a terminal is different from a locating reference for position information of a physical store in the prior art, which causes a large deviation between a relative position of the position information of the terminal and a relative position of the position information of the physical store, the information obtaining method provided by this embodiment of the present disclosure can determine, by using a same server, position information of a geographical building and position information of a user terminal that are required by a user, thereby improving the accuracy of locating the geographical building.

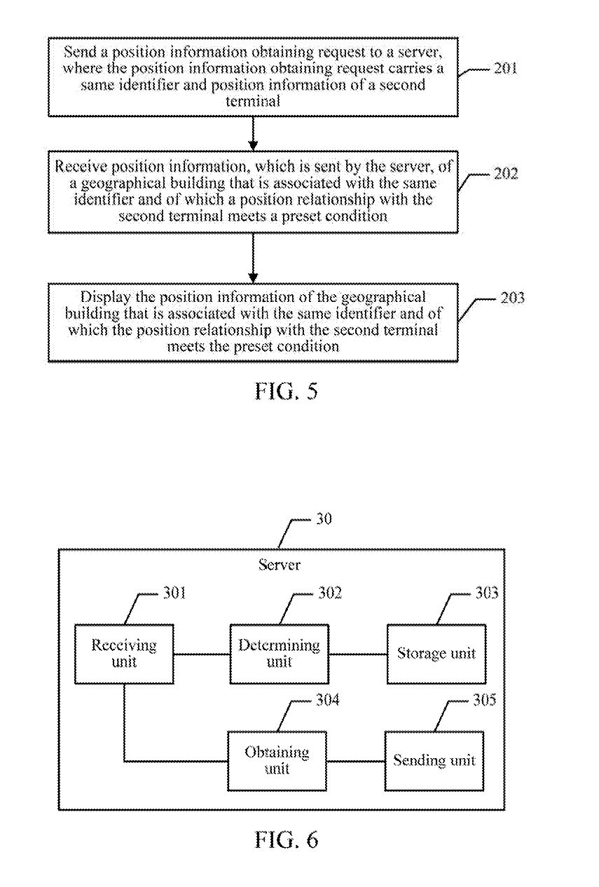

Referring to FIG. 5, another embodiment of an information obtaining method provided by an embodiment of the present disclosure includes:

201: Send a position information obtaining request to a server, where the position information obtaining request carries a same identifier and position information of a second terminal.

202: Receive position information, which is sent by the server, of a geographical building that is associated with the same identifier and of which a position relationship with the second terminal meets a preset condition.

203: Display the position information of the geographical building that is associated with the same identifier and of which the position relationship with the second terminal meets the preset condition.

Compared with that a locating reference for position information of a terminal is different from a locating reference for position information of a physical store in the prior art, which causes a large deviation between a relative position of the position information of the terminal and a relative position of the position information of the physical store, the information obtaining method provided by this embodiment of the present disclosure can determine, by using a same server, position information of a geographical building and position information of a user terminal that are required by a user, thereby improving the accuracy of locating the geographical building.

Optionally, in another embodiment of the information obtaining method provided by this embodiment of the present disclosure, when the position information of the second terminal is position information of the second terminal, the receiving position information, which is sent by the server, of a geographical building that is associated with the same identifier and of which a position relationship with the second terminal meets a preset condition may include:

receiving the position information, which is sent by the server, of the geographical building of which a distance to the second terminal is within a preset range; and

the displaying the position information of the geographical building that is associated with the same identifier and of which a position relationship with the second terminal meets a preset condition includes:

displaying the position information of the geographical building of which the distance to the second terminal is within the preset range.

Optionally, in another embodiment of the information obtaining method provided by this embodiment of the present disclosure, the receiving position information, which is sent by the server, of a geographical building that is associated with the same identifier and of which a position relationship with the second terminal meets a preset condition may include:

receiving the position information, which is sent by the server, of the geographical building in a service area in which the second terminal is located; and

the displaying the position information of the geographical building that is associated with the same identifier and of which a position relationship with the second terminal meets a preset condition includes:

displaying the position information of the geographical building in the service area in which the second terminal is located.

Optionally, in another embodiment of the information obtaining method provided by this embodiment of the present disclosure, the method may further include:

receiving a selection instruction input by a user, where the selection instruction is used to instruct to select the position information of the geographical building specified by the user; and

selecting, according to the selection instruction, the position information of the geographical building specified by the user.

Optionally, in another embodiment of the information obtaining method provided by this embodiment of the present disclosure, the method may further include:

reporting the position information, which is selected by the user, of the geographical building to the server.

Reference may be made to functions of the terminal in the embodiments corresponding to FIG. 1 to FIG. 3 to understand the information obtaining method described in the embodiment corresponding to FIG. 5 and optional embodiments of the present disclosure, which are not described in detail herein again.

Compared with that a locating reference for position information of a terminal is different from a locating reference for position information of a physical store in the prior art, which causes a large deviation between a relative position of the position information of the terminal and a relative position of the position information of the physical store, the information obtaining method provided by this embodiment of the present disclosure can determine, by using a same server, position information of a geographical building and position information of a user terminal that are required by a user, thereby improving the accuracy of locating the geographical building.

Referring to FIG. 6, an embodiment of a server provided by an embodiment of the present disclosure includes:

a receiving unit 301, configured to receive position description information of a geographical building associated with a same identifier and reported by a first terminal;

a determining unit 302, configured to determine position information of the geographical building according to the position description information of the geographical building received by the receiving unit 301;

a storage unit 303, configured to store, in an associated manner, the same identifier and the position information of the geographical building determined by the determining unit 302, where

the receiving unit 301 is further configured to receive a position information obtaining request sent by a second terminal, where the position information obtaining request carries the same identifier and position information of the second terminal, and a locating reference of the second terminal is the same as a locating reference of the server;

an obtaining unit 304, configured to obtain, according to the position information of the second terminal received by the receiving unit 301 and the same identifier, the position information of the geographical building that is associated with the same identifier and of which a position relationship with the second terminal meets a preset condition; and

a sending unit 305, configured to send, to the second terminal, the position information, which is obtained by the obtaining unit 304, of the geographical building that is associated with the same identifier and of which the position relationship with the second terminal meets the preset condition.

Compared with that a locating reference for position information of a terminal is different from a locating reference for position information of a physical store in the prior art, which causes a large deviation between a relative position of the position information of the terminal and a relative position of the position information of the physical store, the server provided by this embodiment of the present disclosure determines position information of a geographical building and position information of a user terminal that are required by a user, thereby improving the accuracy of locating the geographical building.

Optionally, based on the foregoing embodiment corresponding to FIG. 6, in another embodiment of the server provided by this embodiment of the present disclosure,

the obtaining unit 304 is configured to obtain, according to the same identifier, the position information of the geographical building associated with the same identifier, and determine, according to the position information of the second terminal, the position information of the geographical building of which a distance to the second terminal is within a preset range; and

the sending unit 305 is configured to send, to the second terminal, the position information of the geographical building of which the distance to the second terminal is within the preset range.

Optionally, based on the foregoing embodiment corresponding to FIG. 4, in another embodiment of the server provided by this embodiment of the present disclosure, when the position information of the second terminal is range information of a service area in which the second terminal is located,

the obtaining unit 304 is configured to obtain, according to the same identifier, the position information of the geographical building associated with the same identifier, and determine, according to the range information of the service area in which the second terminal is located, the position information of the geographical building in the service area in which the second terminal is located; and

the sending unit 305 is configured to send, to the second terminal, the position information of the geographical building in the service area in which the second terminal is located.

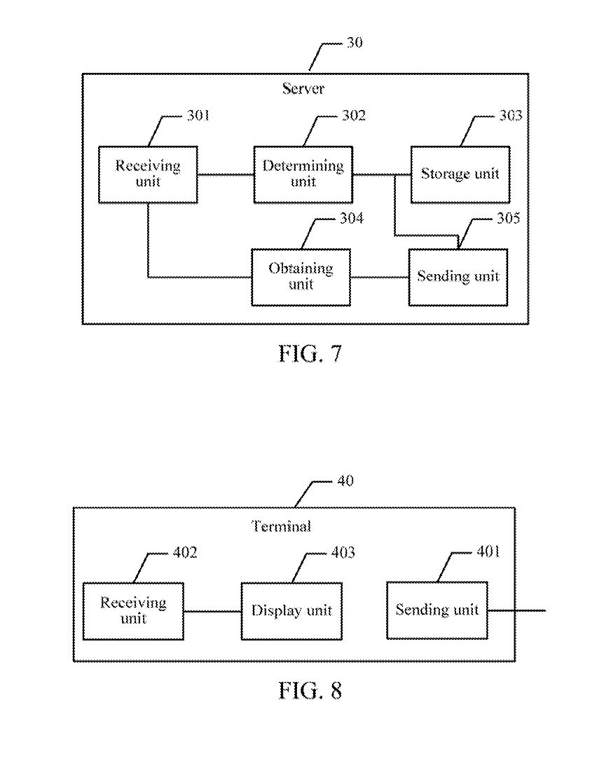

Optionally, based on the foregoing embodiment corresponding to FIG. 6 or optional embodiments, referring to FIG. 7, in another embodiment of the server provided by this embodiment of the present disclosure,

the receiving unit 301 is further configured to receive the position information, which is selected by a user and reported by the second terminal, of the geographical building;

the determining unit 302 is further configured to determine, according to the position information, which is selected by the user and received by the receiving unit 301, of the geographical building, content information associated with the position information, which is selected by the user, of the geographical building; and

the sending unit 305 is further configured to send, to the second terminal, the content information that is associated with the position information, which is selected by the user, of the geographical building and that is determined by the determining unit 302.

Referring to FIG. 8, an embodiment of a terminal provided by an embodiment of the present disclosure includes:

a sending unit 401, configured to send a position information obtaining request to a server, where the position information obtaining request carries a same identifier and position information of a second terminal, and a locating reference of the second terminal is the same as a locating reference of the server;

a receiving unit 402, configured to receive position information, which is sent by the server, of a geographical building that is associated with the same identifier and of which a position relationship with the second terminal meets a preset condition; and

a display unit 403, configured to display the position information, which is received by the receiving unit 402, of the geographical building that is associated with the same identifier and of which the position relationship with the second terminal meets the preset condition.

Compared with that a locating reference for position information of a terminal is different from a locating reference for position information of a physical store in the prior art, which causes a large deviation between a relative position of the position information of the terminal and a relative position of the position information of the physical store, the terminal provided by this embodiment of the present disclosure can determine, by using a same server, position information of a geographical building and position information of a user terminal that are required by a user, thereby improving the accuracy of locating the geographical building.

Optionally, based on the foregoing embodiment corresponding to FIG. 8, in another embodiment of the terminal provided by this embodiment of the present disclosure,

the receiving unit 402 is configured to receive the position information, which is sent by the server, of the geographical building of which a distance to the second terminal is within a preset range; and

the display unit 403 is configured to display the position information of the geographical building of which the distance to the second terminal is within the preset range.

Optionally, based on the foregoing embodiment corresponding to FIG. 8, in another embodiment of the terminal provided by this embodiment of the present disclosure, when the position information of the second terminal is range information of a service area in which the second terminal is located,

the receiving unit 402 is configured to receive the position information, which is sent by the server, of the geographical building in the service area in which the second terminal is located; and

the display unit 403 is configured to display the position information of the geographical building in the service area in which the second terminal is located.

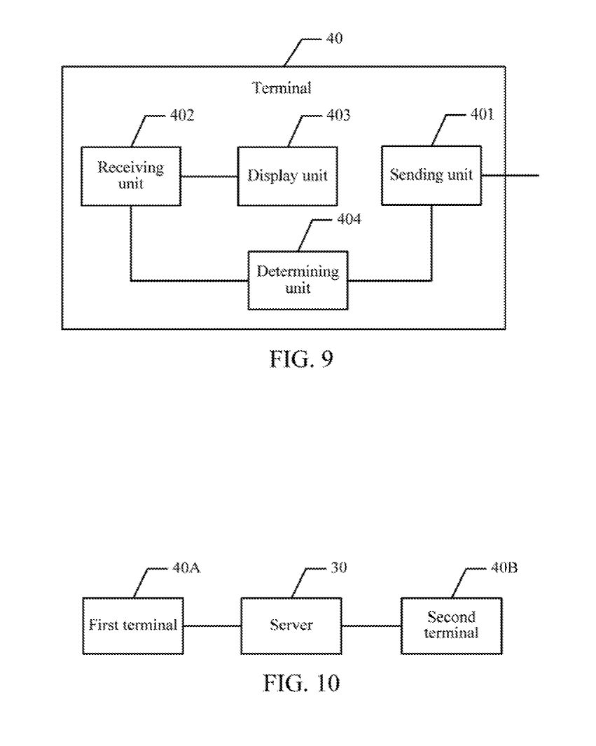

Optionally, based on the foregoing embodiment corresponding to FIG. 8, referring to FIG. 9, in another embodiment of the terminal provided by this embodiment of the present disclosure,

the receiving unit 402 is further configured to receive a selection instruction input by a user, where the selection instruction is used to instruct to select the position information of the geographical building specified by the user;

the terminal 40 further includes:

a determining unit 404, configured to select, according to the selection instruction received by the receiving unit 402, the position information of the geographical building specified by the user; and

the sending unit 401 is further configured to report the position information, which is selected by the user and determined by the determining unit 404, of the geographical building to the server.

Referring to FIG. 10, an embodiment of an information obtaining system provided by an embodiment of the present disclosure includes: a first terminal 40A, a second terminal 40B, and a server 30, where the first terminal 40A, the second terminal 40B, and the server 30 are in communication connection.

Reference may be made to the embodiments corresponding to FIG. 1 to FIG. 3 to understand interaction processes between and respective functions of the first terminal 40A, the second terminal 40B, and the server 30, which are not described in detail herein again.

A person of ordinary skill in the art may understand that all or some steps in the methods in the foregoing embodiments can be performed by a program instructing relevant hardware. The program may be stored in a computer readable storage medium, where the storage medium may include a ROM, a RAM, a magnetic disk, or an optical disc.

The information obtaining method, server, terminal, and system that are provided by the embodiments of the present disclosure are described in detail above. The principles and implementation manners of the present disclosure are described herein by using specific examples. The descriptions of the foregoing embodiments are merely provided for ease of understand the methods and core ideas of the present disclosure. Meanwhile, a person of ordinary skill in the art may make modifications to specific implementation manners and application ranges according to the ideas of the present disclosure. To sum up, the content of the specification shall not be construed as a limitation to the present disclosure.

What is claimed is:

1. An information obtaining method, comprising:
reporting, by a first terminal, position description information of a geographical building associated with a same identifier to a server;
determining, by the server, position information of the geographical building according to the position description information of the geographical building, and storing the same identifier and the position information of the geographical building in an associated manner;
sending, by a second terminal, a position information obtaining request to the server, wherein the position information obtaining request carries the same identifier and position information of the second terminal, and a locating reference of the second terminal is the same as a locating reference of the server;
obtaining, by the server according to the position information of the second terminal and the same identifier, the position information of the geographical building that is associated with the same identifier and of which a position relationship with the second terminal meets a preset condition;
sending, by the server to the second terminal, the position information of the geographical building that is associated with the same identifier and of which the position relationship with the second terminal meets the preset condition; and
displaying, by the second terminal, the position information of the geographical building that is associated with the same identifier and of which the position relationship with the second terminal meets the preset condition.

2. The method according to claim 1, wherein the obtaining, by the server according to the position information of the second terminal and the same identifier, the position information of the geographical building that is associated with the same identifier and of which a position relationship with the second terminal meets a preset condition comprises:
obtaining, by the server according to the same identifier, the position information of the geographical building associated with the same identifier; and
determining, by the server according to the position information of the second terminal, the position information of the geographical building of which a distance to the second terminal is within a preset range.

3. The method according to claim 2, wherein the sending, by the server to the second terminal, the position information of the geographical building that is associated with the same identifier and of which the position relationship with the second terminal meets the preset condition comprises:
sending, by the server, the position information of the geographical building of which the distance to the second terminal is within the preset range to the second terminal; and
the displaying, by the second terminal, the position information of the geographical building that is associated with the same identifier and of which the position relationship with the second terminal meets the preset condition comprises:
displaying, by the second terminal, the position information of the geographical building of which the distance to the second terminal is within the preset range.

4. The method according to claim 1, wherein when the position information of the second terminal is range information of a service area in which the second terminal is located, the obtaining, by the server according to the position information of the second terminal and the same identifier, the position information of the geographical building that is associated with the same identifier and of which a position relationship with the second terminal meets a preset condition comprises:
obtaining, by the server according to the same identifier, the position information of the geographical building associated with the same identifier; and
determining, by the server according to the range information of the service area in which the second terminal is located, the position information of the geographical building in the service area in which the second terminal is located.

5. The method according to claim 4, wherein the sending, by the server to the second terminal, the position information of the geographical building that is associated with the same identifier and of which the position relationship with the second terminal meets the preset condition comprises:
sending, by the server to the second terminal, the position information of the geographical building in the service area in which the second terminal is located; and
the displaying, by the second terminal, the position information of the geographical building that is associated with the same identifier and of which the position relationship with the second terminal meets the preset condition comprises:
displaying, by the second terminal, the position information of the geographical building in the service area in which the second terminal is located.

6. The method according to claim 3, wherein the method further comprises:
receiving, by the second terminal, a selection instruction input by a user, wherein the selection instruction is used to instruct to select the position information of the geographical building specified by the user; and
selecting, according to the selection instruction, the position information of the geographical building specified by the user.

7. The method according to claim 6, wherein the method further comprises:
receiving, by the server, the position information, which is selected by the user and reported by the second terminal, of the geographical building;
determining, according to the position information, which is selected by the user, of the geographical building, content information associated with the position information, which is selected by the user, of the geographical building; and
sending the content information associated with the position information, which is selected by the user, of the geographical building to the second terminal.

8. An information obtaining method applied to a server, the method comprising:
at the server having one or more processors and memory for storing one or more programs to be executed by the one or more processors:
receiving position description information, which is reported by a first terminal, of a geographical building associated with a same identifier;
determining position information of the geographical building according to the position description information of the geographical building, and storing the same identifier and the position information of the geographical building in an associated manner;
receiving a position information obtaining request sent by a second terminal, wherein the position information obtaining request carries the same identifier and position information of the second terminal, and a locating reference of the second terminal is the same as a locating reference of the server;
obtaining, according to the position information of the second terminal and the same identifier, the position information of the geographical building that is associated with the same identifier and of which a position relationship with the second terminal meets a preset condition; and
sending, to the second terminal, the position information of the geographical building that is associated with the same identifier and of which the position relationship with the second terminal meets the preset condition.

9. The method according to claim 8, wherein the obtaining, according to the position information of the second terminal and the same identifier, the position information of the geographical building that is associated with the same identifier and of which a position relationship with the second terminal meets a preset condition comprises:
obtaining, according to the same identifier, the position information of the geographical building associated with the same identifier; and
determining, according to the position information of the second terminal, the position information of the geographical building of which a distance to the second terminal is within a preset range.

10. The method according to claim 9, wherein the sending to the second terminal, the position information of the geographical building that is associated with the same identifier and of which the position relationship with the second terminal meets the preset condition comprises:
sending the position information of the geographical building of which the distance to the second terminal is within the preset range to the second terminal.

11. The method according to claim 8, wherein when the position information of the second terminal is range information of a service area in which the second terminal is located, the obtaining, according to the position information of the second terminal and the same identifier, the position information of the geographical building that is associated with the same identifier and of which a position relationship with the second terminal meets a preset condition comprises:
obtaining, according to the same identifier, the position information of the geographical building associated with the same identifier; and
determining, according to the range information of the service area in which the second terminal is located, the position information of the geographical building in the service area in which the second terminal is located.

12. The method according to claim 11, wherein the sending, to the second terminal, the position information of the geographical building that is associated with the same identifier and of which a position relationship with the second terminal meets a preset condition comprises:
sending, to the second terminal, the position information of the geographical building in the service area in which the second terminal is located.

13. The method according to claim 8, wherein the method further comprises:
receiving the position information, which is selected by the user and reported by the second terminal, of the geographical building;
determining, according to the position information, which is selected by the user, of the geographical building, content information associated with the position information, which is selected by the user, of the geographical building; and
sending the content information associated with the position information, which is selected by the user, of the geographical building to the second terminal.

14. A server, comprising:
one or more processors;
a memory storing program modules;
the program modules executed by the one or more processors for performing an information obtaining method, the program modules comprising
a receiving unit, configured to receive position description information, which is reported by a first terminal, of a geographical building associated with a same identifier;
a determining unit, configured to determine position information of the geographical building according to the position description information of the geographical building received by the receiving unit;
a storage unit, configured to store, in an associated manner, the same identifier and the position information of the geographical building determined by the determining unit, wherein
the receiving unit is further configured to receive a position information obtaining request sent by a second terminal, wherein the position information obtaining request carries the same identifier and position information of the second terminal, and a locating reference of the second terminal is the same as a locating reference of the server;
an obtaining unit, configured to obtain, according to the position information of the second terminal received by the receiving unit and the same identifier, the position information of the geographical building that is associated with the same identifier and of which a position relationship with the second terminal meets a preset condition; and
a sending unit, configured to send, to the second terminal, the position information, which is obtained by the obtaining unit, of the geographical building that is associated with the same identifier and of which the position relationship with the second terminal meets the preset condition.

15. The server according to claim 14, wherein
the obtaining unit is configured to obtain, according to the same identifier, the position information of the geographical building associated with the same identifier; and determine, according to the position information of the second terminal, the position information of the geographical building of which a distance to the second terminal is within a preset range.

16. The server according to claim 15, wherein
the sending unit is configured to send, to the second terminal, the position information of the geographical building of which the distance to the second terminal is within a preset range.

17. The server according to claim 14, wherein when the position information of the second terminal is range information of a service area in which the second terminal is located,
the obtaining unit is configured to obtain, according to the same identifier, the position information of the geographical building associated with the same identifier, and determine, according to the range information of the service area in which the second terminal is located, the position information of the geographical building in the service area in which the second terminal is located.

18. The server according to claim 17, wherein
the sending unit is configured to send, to the second terminal, the position information of the geographical building in the service area in which the second terminal is located.

19. The server according to claim 14, wherein
the receiving unit is further configured to receive the position information, which is selected by a user and reported by the second terminal, of the geographical building;
the determining unit is further configured to determine, according to the position information, which is selected by the user and received by the receiving unit, of the geographical building, content information associated with the position information, which is selected by the user, of the geographical building; and
the sending unit is further configured to send, to the second terminal, the content information that is associated with the position information, which is selected by the user, of the geographical building and that is determined by the determining unit.

20. An information obtaining system, comprising: a first terminal, a second terminal, and a server, wherein the first terminal, the second terminal, and the server are in communication connection;
the first terminal reports position description information of a geographical building associated with a same identifier to a server;
the server determines position information of the geographical building according to the position description information of the geographical building, and stores the same identifier and the position information of the geographical building in an associated manner;
the second terminal sends a position information obtaining request to the server, wherein the position information obtaining request carries the same identifier and position information of the second terminal, and a locating reference of the second terminal is the same as a locating reference of the server;
the server obtains, according to the position information of the second terminal and the same identifier, the position information of the geographical building that is associated with the same identifier and of which a position relationship with the second terminal meets a preset condition;
the server sends, to the second terminal, the position information of the geographical building that is associated with the same identifier and of which the position relationship with the second terminal meets the preset condition; and
the second terminal displays the position information of the geographical building that is associated with the same identifier and of which the position relationship with the second terminal meets the preset condition.
